(19) United States
(12) Patent Application Publication
(10) Pub. No.: US 2023/0003149 A1
(43) Pub. Date: Jan. 5, 2023

(54) SYSTEMS AND METHODS FOR DIESEL PARTICULATE FILTER REGENERATION USING AIR FROM VEHICLE COMPRESSED AIR

(71) Applicant: THERMO KING CORPORATION, Minneapolis, MN (US)

(72) Inventors: Adam B. Carey, Minneapolis, MN (US); Jimmy Goodsell, Minneapolis, MN (US); Justin Brookman, Minneapolis, MN (US)

(21) Appl. No.: 17/363,969

(22) Filed: Jun. 30, 2021

(51) Int. Cl. F01N 3/027; B60H 1/00

(52) U.S. Cl. CPC F01N 3/027; B60H 1/00014; B60H 1/00871

(57) ABSTRACT

Systems and methods for diesel particulate filter regeneration for a transport climate control system are provided. The diesel particulate filter regeneration system for the transport climate control system includes a prime mover having an ON state and an OFF state, a diesel particulate filter (DPF) disposed downstream from the prime mover, an airflow control device upstream from the DPF, an air source configured to provide air to the DPF via the airflow control device, and a controller. The air source is configured to supply air to air components of a vehicle. When the prime mover is in the OFF state, the controller is configured to control the airflow control device to supply air from the air source to the DPF for diesel particulate filter regeneration.

### FIELD

This disclosure relates generally to diesel particulate filter (DPF) regeneration for a transport climate control system (TCCS). More specifically, the disclosure relates to systems and methods for DPF regeneration for a TCCS using vehicle compressed air.

### BACKGROUND

A TCCS can include, for example, a transport refrigeration system (TRS) and/or a heating, ventilation and air conditioning (HVAC) system. A TRS is generally used to control an environmental condition (e.g., temperature, humidity, air quality, and the like) within a cargo space of a transport unit (e.g., a truck, a container (such as a container on a flat car, an intermodal container, etc.), a box car, a semi-tractor, a bus, or other similar transport unit). The TRS can maintain environmental condition(s) of the cargo space to maintain cargo (e.g., produce, frozen foods, pharmaceuticals, etc.). In some embodiments, the transport unit can include a HVAC system to control a climate within a passenger space of the vehicle.

### SUMMARY

This disclosure relates generally to DPF regeneration for a TCCS. More specifically, the disclosure relates to systems and methods for DPF regeneration for a TCCS using vehicle compressed air.

Embodiments disclosed herein can provide air line(s) attached to an air source such as the vehicle compressed air system with an airflow control device (e.g., orifice, valve such as solenoid valve or check valve, or the like) attached to the air line(s) and fed into the exhaust line or the air system. When air and/or oxygen is needed to support thermal management, DPF regeneration, or the like, air can be supplied from the air source such as the vehicle compressed air system.

Embodiments disclosed herein can provide a DPF attached to a prime mover (of an APU or of a TCCS or the like) that can regenerate while the prime mover is off, by powering a heater (e.g., an electric heater or the like) from a power source (e.g., the vehicle power system, the APU battery, the TCCS battery, etc.) and supplying air/oxygen from an air source to the DPF. Embodiments disclosed herein can utilize air (e.g., compressed air or the like) from the vehicle and an airflow control device (e.g., a metering or on/off device or the like) to provide a desired supply of air or oxygen without the use of a separate air pump. Embodiments disclosed herein can reduce the number of components required for providing DPF regeneration and thereby reduce overall weight for the TCCS, and simplify electrical wiring within the TCCS.

In an embodiment, a diesel particulate filter regeneration system for a transport climate control system is provided. The diesel particulate filter regeneration system includes a prime mover having an ON state and an OFF state, a diesel particulate filter (DPF) disposed downstream from the prime mover, an airflow control device disposed upstream from the DPF, an air source configured to provide air to the DPF via the airflow control device, and a controller. When the prime mover is in the OFF state, the controller is configured to control the airflow control device to supply air from the air source to the DPF for diesel particulate filter regeneration.

In an embodiment, a method for diesel particulate filter regeneration for a transport climate control system is provided. The method includes determining that a prime mover is in an ON state. The method also includes when the prime mover is determined to be in the OFF state, a controller instructing an airflow control device to supply air from an air source to a diesel particulate filter (DPF) for diesel particulate filter regeneration. The DPF is disposed downstream from the prime mover. The airflow control device is disposed upstream from the DPF. The method further includes the air source supplying air to the DPF via the airflow control device. The air source is configured to supply air to air components of a vehicle.

Other features and aspects will become apparent by consideration of the following detailed description and accompanying drawings.

### BRIEF DESCRIPTION OF THE DRAWINGS

References are made to the accompanying drawings that form a part of this disclosure and which illustrate the embodiments in which systems and methods described in this specification can be practiced.

FIG. 1A illustrates a schematic cross sectional side view of a refrigerated transport unit with a multi-temp transport refrigeration system (MTRS), according to an embodiment.

FIG. 1B illustrates a perspective view of a vehicle with an APU, according to an embodiment.

FIG. 1C illustrates a side view of a truck with a front wall mounted vehicle powered transport refrigeration unit, according to an embodiment.

FIG. 2 illustrates a schematic view of diesel particulate filter regeneration system for a transport climate control system, according to an embodiment.

FIG. 3 is a flow chart illustrating a method for diesel particulate filter regeneration for a transport climate control system, according to an embodiment.

Like reference numbers represent like parts throughout.

### DETAILED DESCRIPTION

This disclosure relates generally to DPF regeneration for a TCCS. More specifically, the disclosure relates to systems and methods for DPF regeneration for a TCCS using vehicle compressed air.

As defined herein, the phrase “diesel particulate filter” or “DPF” may refer to a device designed to remove e.g., diesel particulate matter, soot, or the like from the exhaust gas of a prime mover (e.g., a diesel powered compression ignition engine or the like). It will be appreciated that unless specified otherwise, a prime mover described herein refers to a prime mover of an auxiliary power unit (APU), a prime mover of a TCCS, or the like, other than a vehicle prime mover. That is, in some embodiments, there can be two or more distinct diesel engines on a same vehicle: one can be a main/vehicle (e.g., tractor, truck, or the like) engine, and the other can be a diesel powered compression ignition engine (the auxiliary engine) of the APU, TRU, or the like. It will be appreciated that an electric prime mover might not work with a diesel particulate filter. Embodiments disclosed herein can be directed to the diesel particulate filter for the auxiliary diesel powered compression ignition engine.

As defined herein, the phrase “vehicle compressed air” may refer to air from a vehicle including air from vehicle compressor air tank(s) and/or from any other suitable air sources.

As defined herein, the phrase “upstream” may refer to an opposite direction from that in which air flows, and/or refer to nearer to the air source. The phrase “downstream” may refer to the direction in which air flows, and/or refer to away from the air source.

In an embodiment, an air pump (e.g., an electric air pump controlled and driven off an APU system or the like) and airflow control device(s) (e.g., valves or the like) can be used to provide air/oxygen to the DPF. Embodiments disclosed herein can simplify the components needed (e.g., eliminate the components needed for airflow and reuse the components already in the vehicle) to provide air/oxygen to the DPF for DPF regeneration without the use of an air pump. Embodiments disclosed herein can be applicable to e.g., box truck, self-powered truck, trailer, TRU, or the like), or dual prime mover system where a prime mover is independent to a vehicle prime mover.

Embodiments disclosed herein can provide compressed air supplied to an exhaust system, and can provide an airflow control device (e.g., metering, on/off device, or the like) to control airflow to the exhaust system.

Embodiments disclosed herein can provide compressed air line(s) attached to an air source such as vehicle auxiliary or secondary compress air tank(s) or manifold or branched off existing vehicle air lines. The air line(s) can be attached to an exhaust system (e.g., the exhaust system of an APU or a TCCS or the like) with an airflow control device (e.g., on/off solenoid, orifice, multi-position control valve, or the like) in the air line(s). Electrical power for the airflow control device can be from the APU (or the TCCS) or the vehicle system. The control of the airflow control device is performed by a controller (e.g., the APU controller, the TCCS controller, or the like).

It will be appreciated that when the vehicle is operational and DPF regeneration is required, the controller can turn on, adjust the airflow control device in the compressed air system to allow air/oxygen to the DPF, and/or turn on a heater (e.g., an electric heater or the like) to perform DPF regeneration for the collected particulate (e.g., soot or the like). The control of the heater and air supply (by controlling the airflow control device) can be separate from each other and do not need to start or end at the same time or be the same length in duration.

It will also be appreciated that when the controller determines that DPF regeneration is complete, the controller can turn itself off, adjust the airflow control device in the compressed air system, and/or turn off the heater. The control of the heater and air supply (via control of the airflow control device) can be separate from each other and do not need to start or end at the same time or be the same length in duration.

It will further be appreciated that a pressure sensor on the APU system or on the TCCS can be used to determine when DPF regeneration is required, and can also be used as a diagnostic for a failure in the compressed air line. For example, if the APU is off and the APU controller has not demanded air, but the pressure sensor detects an abnormally high air pressure, a fault can be generated.

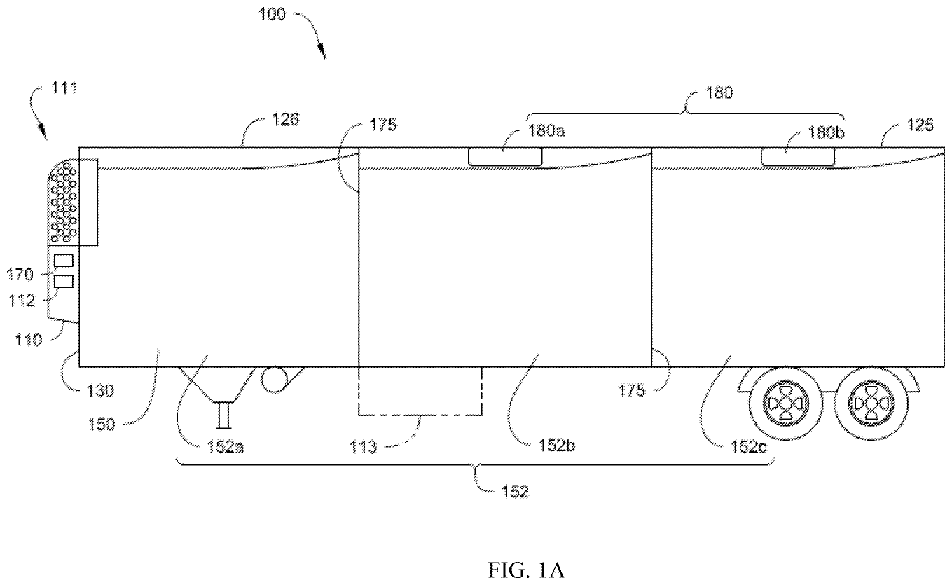

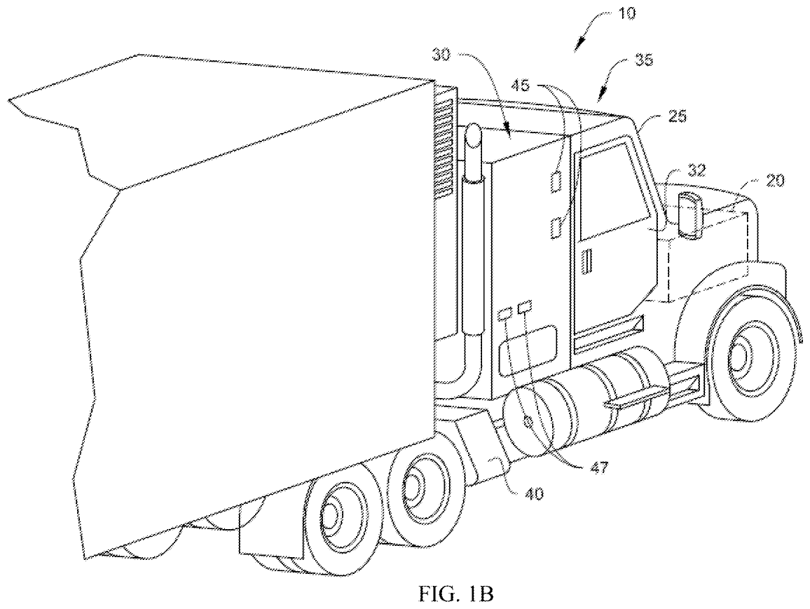

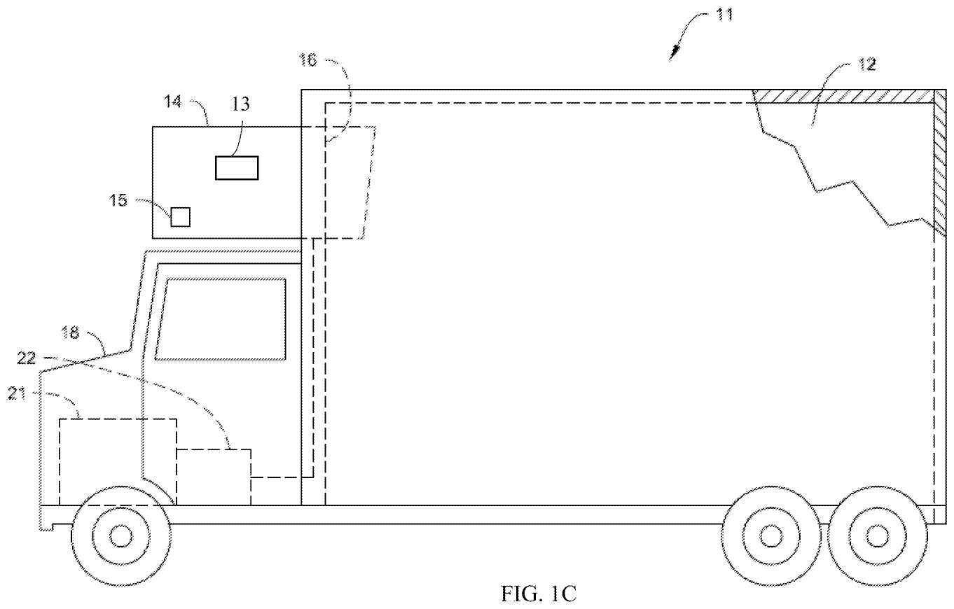

FIG. 1A illustrates one embodiment of a MTRS 100 for a TU 125 that can be towed, for example, by a tractor (not shown). The MTRS 100 includes a TRU 110 that provides environmental control (e.g. temperature, humidity, air quality, etc.) within an internal space 150 of the TU 125. The MTRS 100 also includes a MTRS controller 170 and one or more sensors (e.g., Hall effect sensors, current transducers, etc.) that are configured to measure one or more parameters (e.g., ambient temperature, compressor suction pressure, compressor discharge pressure, supply air temperature, return air temperature, humidity, etc.) of the MTRS 100 and communicate parameter data to the MTRS controller 170. The MTRS 100 is powered by a power module 112. The TRU 110 is disposed on a front wall 130 of the TU 125. In other embodiments, it will be appreciated that the TRU 110 can be disposed, for example, on a rooftop 126 or another wall of the TU 125.

In some embodiments, the MTRS 100 can include an undermount unit 113. In some embodiments, the undermount unit 113 can be a TRU that can also provide environmental control (e.g. temperature, humidity, air quality, etc.) within the internal space 150 of the TU 125. The undermount unit 113 can work in combination with the TRU 110 to provide redundancy or can replace the TRU 110. Also, in some embodiments, the undermount unit 113 can be a power module that includes, for example, a generator that can help power the TRU 110.

The programmable MTRS Controller 170 may comprise a single integrated control unit or may comprise a distributed network of TRS control elements. The number of distributed control elements in a given network can depend upon the particular application of the principles described herein. The MTRS controller 170 is configured to control operation of the MTRS 100.

As shown in FIG. 1A, the power module 112 is disposed in the TRU 110. In other embodiments, the power module 1 12 can be separate from the TRU 110. Also, in some embodiments, the power module 112 can include two or more different power sources disposed within or outside of the TRU 110. In some embodiments, the power module 112 can include one or more of a prime mover, a battery, an alternator, a generator, a solar panel, a fuel cell, etc. Also, the prime mover can be a combustion engine or a microturbine engine and can operate as a two speed prime mover, a variable speed prime mover, etc. In some embodiments, the prime mover can include a DPF to collect particulate such as carbon, soot, or the like that comes out of the tail pipe. The power module 112 can provide power to, for example, the MTRS Controller 170, a compressor (not shown), a plurality of DC (Direct Current) components (not shown), a power management unit (not shown), etc. The DC components can be accessories or components of the MTRS 100 that require DC power to operate. Examples of the DC components can include, for example, DC fan motor(s) for a condenser fan or an evaporator blower (e.g., an Electrically Commutated Motor (ECM), a Brushless DC Motor (BLDC), etc.), a fuel pump, a drain tube heater, solenoid valves (e.g., controller pulsed control valves), etc.

The power module 112 can include a DC power source (not shown) for providing DC electrical power to the plurality of DC components (not shown), the power management unit (not shown), etc. The DC power source can receive mechanical and/or electrical power from, for example, a utility power source (e.g., Utility power, etc.), a prime mover (e.g., a combustion engine such as a diesel engine, etc.) coupled with a generator machine (e.g., a belt-driven alternator, a direct drive generator, etc.), etc. For example, in some embodiments, mechanical energy generated by a diesel engine is converted into electrical energy via a generator machine. The electrical energy generated via the belt driven alternator is then converted into DC electrical power via, for example, a bi-directional voltage converter. The bi-directional voltage converter can be a bi-directional multi-battery voltage converter.

The internal space 150 can be divided into a plurality of zones 152. The term “zone” means a part of an area of the internal space 150 separated by walls 175. It will be appreciated that the invention disclosed herein can also be used in a single zone TRS.

The MTRS 100 for the TU 125 includes the TRU 110 and a plurality of remote evaporator units 180. In some embodiments, an HVAC system can be powered by an Auxiliary Power Unit (APU, see FIG. 1B). The APU can be operated when a main prime mover of the TU 125 is turned off such as, for example, when a driver parks the TU 125 for an extended period of time to rest. The APU can provide, for example, power to operate a secondary HVAC system to provide conditioned air to a cabin of the TU 125. The APU can also provide power to operate cabin accessories within the cabin such as a television, a microwave, a coffee maker, a refrigerator, etc. The APU can be a mechanically driven APU (e.g., prime mover driven) or an electrically driven APU (e.g., battery driven).

The tractor includes a vehicle electrical system for supplying electrical power to the electrical loads of the tractor, the MTRS 100, and/or the TU 125. In some embodiments, the tractor can include a compressor that can compress air and store the compressed air in compressor tank(s).

FIG. 1B illustrates a vehicle 10 according to one embodiment. The vehicle 10 is a semi-tractor that is used to transport cargo stored in a cargo compartment (e.g., a container, a trailer, etc.) to one or more destinations. Hereinafter, the term “vehicle” shall be used to represent all such tractors and trucks, and shall not be construed to limit the invention's application solely to a tractor in a tractor-trailer combination. In some embodiments, the vehicle 10 can be, for example, a straight truck, van, etc. In some embodiments, the vehicle 10 can include a compressor that can compress air and store the compressed air in compressor tank(s).

The vehicle 10 includes a primary power source 20, a cabin 25 defining a sleeping portion 30 and a driving portion 35, an APU 40, and a plurality of vehicle accessory components 45 (e.g., electronic communication devices, cabin lights, a primary and/or secondary HVAC system, primary and/or secondary HVAC fan(s), sunshade(s) for a window/windshield of the vehicle 10, cabin accessories, etc.). The cabin 25 can be accessible via a driver side door (not shown) and a passenger side door 32. The cabin 25 can include a primary HVAC system (not shown) that can be configured to provide conditioned air within driving portion 35 and potentially the entire cabin 25, and a secondary HVAC system (not shown) for providing conditioned air within the sleeping portion 30 of the cabin 25. The cabin 25 can also include a plurality of cabin accessories (not shown). Examples of cabin accessories can include, for example, a refrigerator, a television, a video game console, a microwave, device charging station(s), a continuous positive airway pressure (CPAP) machine, a coffee maker, a secondary HVAC system for providing conditioned air to the sleeping portion 30.

The primary power source 20 can provide sufficient power to operate (e.g., drive) the vehicle 10 and any of the plurality of vehicle accessory components 45 and cabin accessory components 47. The primary power source 20 can also provide power to the primary HVAC system and the secondary HVAC system. In some embodiments, the primary power source can be a prime mover such as, for example, a combustion engine (e.g., a diesel engine, etc.).

The APU 40 is a secondary power unit for the vehicle 10 when the primary power source 20 is unavailable. When, for example, the primary power source 20 is unavailable, the APU 40 can be configured to provide power to one or more of the vehicle accessory components, the cabin accessories, the primary HVAC system and the secondary HVAC system. In some embodiments, the APU 40 can be an electric powered APU. In other embodiments, the APU 40 can be a prime mover powered APU. The APU 40 can be attached to the vehicle 10 using any attachment method. In some embodiments, the APU 40 can be turned on (i.e., activated) or off (i.e., deactivated) by an occupant (e.g., driver or passenger) of the vehicle 10. The APU 40 generally does not provide sufficient power for operating (e.g., driving) the vehicle 10. The APU 40 can be controlled by an APU controller 41. In some embodiments, the APU 40 can include a prime mover that can include a DPF to collect particulate such as carbon, soot, or the like that comes out of the tail pipe.

FIG. 1C depicts a temperature-controlled straight truck 11 that includes a conditioned load space 12 for carrying cargo. A transport refrigeration unit (TRU) 14 is mounted to a front wall 16 of the load space 12. The TRU 14 is controlled via a controller 15 to provide temperature control within the load space 12. The truck 11 further includes a vehicle power bay 18, which houses a truck prime mover 21, such as a combustion engine (e.g., diesel engine, etc.), that provides power to move the truck 11. In some embodiments, the truck prime mover 21 can work in combination with an optional machine 22 (e.g., an alternator). The TRU 14 includes a prime mover 13. In an embodiment, the prime mover 13 can be a combustion engine (e.g., diesel engine, etc.) to provide power to the TRU 14. In some embodiments, the prime mover 13 can include a DPF to collect particulate such as carbon, soot, or the like that comes out of the tail pipe. In one embodiment, the TRU 14 includes a vehicle electrical system. Also, in some embodiments, the TRU 14 can be powered by the prime mover 13 in combination with a battery power source or by the optional machine 22. In some embodiments, the TRU 14 can also be powered by the truck prime mover 21 in combination with a battery power source or the optional machine 22. In some embodiments, the truck 11 can include a compressor that can compress air and store the compressed air in compressor tank(s).

While FIG. 1C illustrates a temperature-controlled straight truck 11, it will be appreciated that the embodiments described herein can also apply to any other type of transport unit including, but not limited to, a container (such as a container on a flat car, an intermodal container, etc.), a box car, or other similar transport unit.

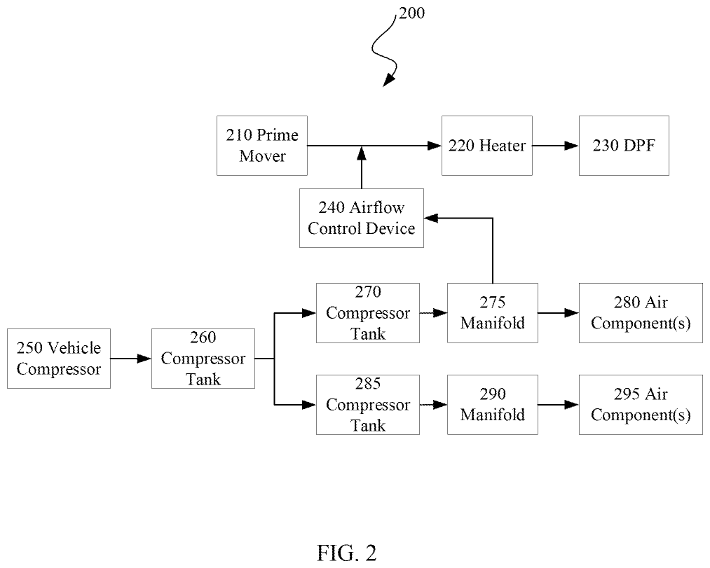

FIG. 2 illustrates a schematic view of diesel particulate filter regeneration system 200 including a prime mover 210 for a transport climate control system, according to an embodiment. The transport climate control system can include, for example, the transport refrigeration unit/system of FIGS. 1A and 1C. The prime mover 210 can be, for example, a prime mover of the APU of FIG. 1B, a prime mover of the transport refrigeration unit/system of FIGS. 1A and 1C, or the like. The APU or TRU or TCCS can include sensors (e.g., temperature, pressure, humidity, motion, voltage, current, battery status, battery charging level, or the like) or the APU or TRU or TCCS can communicate with sensors associated or embedded with a cargo. The controller of the APU or TRU or TCCS can obtain data sensed by the sensors and control the settings of the components (e.g., the airflow control device 240, the heater 220, the prime mover 210 of FIG. 2, or the like) of the TCCS or APU. It will be appreciated that the prime mover 210 is not the vehicle prime mover.

The system 200 also includes a diesel particulate filter (DPF) 230. It will be appreciated that the DPF 230 can be attached to the prime mover 210 to collect particulate such as carbon, soot, or the like that comes out of the tail pipe. It will also be appreciated that some DPFs are designed to burn off the accumulated particulate either passively through the use of a catalyst or by active means such as a heater 220 which is controlled (e.g., when the DPF 230 collected enough particulate) to heat the DPF 230 to a desired temperature (e.g., soot combustion temperatures) to burn off the accumulated particulate. Such process can be defined as DPF regeneration. Controls described herein can be performed by a controller (e.g., the controller of the transport refrigeration unit/system of FIGS. 1A and 1C, the controller of the APU of FIG. 1B, or the like). The controller can connect to and control the components of FIG. 2 via e.g., wireless or wire connections.

As shown in FIG. 2, the arrows indicate the air flow. It will be appreciated that connections between the components of FIG. 2 can be achieved via e.g., pipes, manifolds, or the like. The prime mover 210 and/or pipe design are configured to facilitate the airflow direction. In FIG. 2, the heater 220 is independent to, separated from, and/or disposed downstream from the DPF 230. In an embodiment, the heater 220 can be integrated with the DPF 230. In another embodiment (e.g., passive DPF regeneration through the use of a catalyst), the heater 220 can be optional.

The system 200 further includes an airflow control device 240. In an embodiment, the airflow control device 240 can be a valve or a metering device including an on/off solenoid valve, a check valve, an orifice (e.g., designed to have a desired size to release a predetermined amount of air at a predetermined flow rate), a butterfly-style valve, or the like.

It will be appreciated that the APU battery, the TCCS battery, and/or the vehicle electrical system (including batteries or the like) can provide electrical power to e.g., the airflow control device 240 (if needed), the controller, the heater 220, etc.

The system 200 also includes an air source. In an embodiment, the air source can be one or more of compressor tanks 260, 270, or 285 that can supply air to the DPF 230 via the airflow control device 240. In another embodiment, the air source can be any suitable air source that can supply air to the DPF 230 via the airflow control device 240. The vehicle compressor 250 is configured to supply air to the compressor tanks 260, 270, or 285. In an embodiment, the vehicle compressor 250 can be an air compressor. In an embodiment, the compressor tank 260 can be a wet or storage tank, which can be the first compressor tank where the air from the vehicle compressor 250 may pump into. The compressor tank 260 can connect to the compressor tanks 270, 285 via valves (such as check valves or the like, not shown). One of the compressor tanks 270, 285 can be a primary tank directly feeding air to components such as the rear wheel brake(s) and/or emergency brake(s) at rear or the like. The other one of the compressor tanks 270, 285 can be a secondary tank feeding air to components such as front wheel brake(s) and/or auxiliary or additional air component such as air suspension, air horn, air-operated seats, or the like.

In an embodiment, the compressor tank 270 can connect to and supply air to air component 280 and/or to the airflow control device 240 via manifold 275. The compressor tank 285 can connect to and supply air to air component 295 and/or to the airflow control device 240 via manifold 290. The compressor tank 260 can connect to and supply air to air components 280/295 and/or to the airflow control device 240 via manifold (not shown). The air components 280, 295 can be components such as the rear wheel brake(s), the emergency brake(s), front wheel brake(s), auxiliary/additional air component such as air suspension, air horn, air-operated seats (e.g., in the cab where driver sits), or the like. For example, when a driver hits the brake, the (compressed) air can be transferred from e.g., the compressor tanks 260, 270, 285 or the like and can apply to the air brake(s).

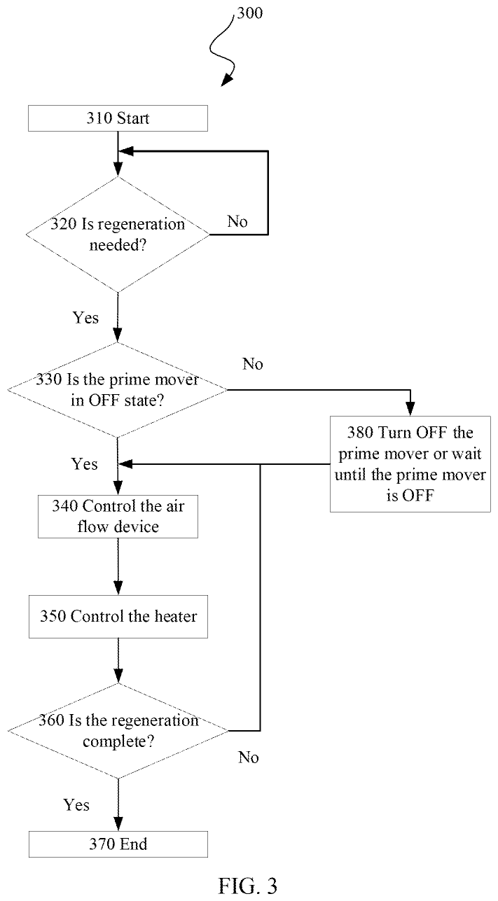

FIG. 3 is a flow chart illustrating a method 300 for diesel particulate filter regeneration for a transport climate control system, according to an embodiment.

It will be appreciated that the process disclosed herein can be conducted by a controller (e.g., the controller of the transport refrigeration unit/system of FIGS. 1A and 1C, the controller of the APU of FIG. 1B, or any suitable processor(s)), unless otherwise specified. The controller can include a processor, memory, and/or communication ports to communicate with e.g., other components of the TCCS or APU or with equipment or systems located in proximity to the TCCS or APU or a cargo load. The controller can communicate with other components using e.g., powerline communications, Pulse Width Modulation (PWM) communications, Local Interconnect Network (LIN) communications, Controller Area Network (CAN) communications, etc., and using any suitable communications including wired and/or wireless, analog and/or digital communications. In an embodiment, the communication can include communications over telematics of the TCCS or APU, which the TCCS or APU may include or which may be communicatively connected to the TCCS (e.g., telematics equipment, mobile phone, vehicle communication system, etc.). The TCCS or APU can include sensors (e.g., temperature, pressure, humidity, motion, voltage, current, battery status, battery charging level, or the like) or the TCCS or APU can communicate with sensors associated or embedded with a cargo. The controller can obtain data sensed by the sensors and control the settings of the components (e.g., the airflow control device 240, the heater 220, the prime mover 210 of FIG. 2, or the like) of the TCCS or APU.

It will also be appreciated that the method 300 can include one or more operations, actions, or functions depicted by one or more blocks. Although illustrated as discrete blocks, various blocks may be divided into additional blocks, combined into fewer blocks, or eliminated, depending on the desired implementation. The method 300 begins at 310.

At 310, the controller performs a sequence of initializations for diesel particulate filter regeneration. The initializations can include e.g., obtaining data from sensor(s). In an embodiment, the system 200 of FIG. 2 can include sensor(s) (e.g., a pressure sensor or the like, not shown) to detect a pressure of the air upstream of (e.g., before passing through) the DPF. In an embodiment, the pressure of the air can be a prime mover exhaust backpressure before passing through the DPF. In an embodiment, a prime mover exhaust backpressure can be defined as an exhaust gas/air pressure that is produced by the prime mover to overcome a resistance (e.g., a hydraulic resistance, or the like) of the exhaust system in order to discharge the gases/air into the atmosphere. The controller can obtain the sensed pressure from the sensor. The method 300 proceeds to 320.

At 320, the controller determines whether DPF regeneration is needed. In an embodiment, the controller obtaining the sensed pressure from the sensor can be performed at 320. If the sensed pressure is not greater than a predetermined threshold (e.g., at or about 12 kPa to at or about 20 kPa of gauge pressure, or the like), the controller determines that DPF regeneration is not needed. The method 300 proceeds back to 320 and continues monitoring the sensed pressure from the sensor. If the sensed pressure is greater than the predetermined threshold, the controller determines that DPF regeneration is needed. It will be appreciated that it may not be necessary to perform DPF regeneration at the time when the DPF is full (of soot). In an embodiment, DPF regeneration can be performed even when the DPF is not full (of soot) to take advantage of the main prime mover providing energy for DPF regeneration. That is, there can be a minimum trigger pressure threshold to perform DPF regeneration and a maximum trigger pressure threshold when DPF regeneration has to be performed. The method 300 proceeds to 330.

At 330, the controller determines an ON or OFF state of the prime mover (e.g., 210 of FIG. 2). The ON state of the prime mover indicates that the prime mover is running. The OFF state of the prime mover indicates that the prime mover is not running. It will be appreciated that when performing DPF regeneration, it is not desirable for an exhaust gas flow from the prime mover to pass through the DPF, and thus the prime mover should not be in the ON state. In an embodiment, the prime mover status (ON state or OFF state) can be determined by e.g., using a sensor measuring engine speed, crankshaft revolutions per minute (RPM), alternator output, or the like. If the controller determines that the prime mover is in the OFF state, the method 300 proceeds to 340. If the controller determines that the prime mover is in the ON state, the method 300 proceeds to 380.

At 380, the controller shuts down the prime mover (e.g., by controlling a fuel solenoid to cut a fuel supply to the prime mover to turn the prime mover off, etc.) so that the prime mover is in the OFF state. In another embodiment, the controller waits until the prime mover is in the OFF state. Once the prime mover is in the OFF state, the method 300 proceeds to 340.

At 340, the controller controls the airflow control device 240 of FIG. 2 to supply air from the air source (compressor tanks 260, 270, 285, or the like) to the DPF 230. It will be appreciated that the amount of oxygen or air flow to the DPF 230 may be desired to meet a predetermined range of acceptability. If the amount of air or oxygen is too little, there may not be enough oxygen for DPF regeneration. If the amount of air or oxygen is too much, the DPF regeneration may not achieve the required temperature (e.g., overcooling of the DPF may occur so that the oxidation/reaction temperature cannot be sufficiently maintained or can be slowed down significantly). In an embodiment, there can be a constant percentage of oxygen in the air (or compressed air), and controlling the airflow control device 240 may be determined based upon, for example, one or more of a desired rate of airflow, a minimum and a maximum amount of air, a size/capacity of the DPF, an amount of particulate (e.g., soot or the like) in the DPF, or the like. It will be appreciated that a desired or certain airflow rate may be desired to provide air for continuous chemical reaction with oxygen to perform the reaction for DPF regeneration. The DPF regeneration sequence including the chemical reaction may take a certain amount of time (e.g., a few minutes or any suitable amount of time) to complete the DPF regeneration. The amount or a total volume of the air needed for DPF regeneration can be based on e.g., the amount of time needed to supply air at the desired rate of airflow and/or the size/capacity of the airflow control device 240. It will be appreciated that the amount or total volume of air needed for DPF regeneration can also be determined based on the amount of soot present. For example, if the DPF is filled (with soot) halfway, the total time of regeneration can be reduced, or the airflow control device 240 (e.g., an air supply valve) can be modulated to match an oxygen to carbon ratio. The method 300 proceeds to 350.

At 350, the controller controls the heater 220 of FIG. 2 to provide heat to the DPF 230 for DPF regeneration. In an embodiment, controlling the heater 220 includes turning the heater 220 on to provide heat to the DPF 230 for a desired period of time to heat the DPF 230 to a desired temperature (e.g., soot combustion temperatures or the like) to burn off the accumulated particulate in the DPF 230. It will be appreciated that DPF regeneration can require both a desired amount of air (and/or a desired rate of airflow for a desired period of time) and a desired temperature (e.g., via heat from the heater 220 or the like). It will also be appreciated that since DPF regeneration needs a desired temperature, if the prime mover is in the ON state, airflow through the heater can be e.g., at or about ten times as much airflow through the heater when the prime mover is in the OFF state, and as such, temperature may not rise to the desired/required temperature for DPF regeneration. Thus, the prime mover may be in the off state for DPF regeneration. The method 300 proceeds to 360.

At 360, the controller determines whether the DPF regeneration is complete. In an embodiment, the DPF regeneration is complete when a predetermined amount of time (measured by, e.g., a timer or the like) has passed after the DPF regeneration is started. If the controller determines that the DPF regeneration is complete, the method 300 proceeds to 370. If the controller determines that the DPF regeneration is not complete, the method 300 proceeds to 340. It will be appreciated that the order of 340 and 350 can be interchangeable.

It will be appreciated that when there is not enough air (e.g., for DPF regeneration or other purpose) in the air source (compressor tanks 260, 270, 285, or the like), the compressor (e.g., the vehicle compressor 250 of FIG. 2) (and/or the vehicle prime mover) can start compressing air. For example, when the vehicle prime mover is running, and when the air in the air source (compressor tanks 260, 270, 285, or the like) is less than a desired pressure e.g., less than at or about 90 pound per square inch (psi), an air signal line to the vehicle compressor (e.g., an air compressor or the like) can indicate a lack of air pressure in the line, and the compressor can be turned on to pump more air to the air source (compressor tanks 260, 270, 285, or the like). When the air in the air source (compressor tanks 260, 270, 285, or the like) is at a desired pressure e.g., e.g., at or about 125 psi, the compressor can be turned off (the vehicle prime mover can be still running). In another example, when the vehicle prime mover is not running, the controller can e.g., detect the air pressure (e.g., via a pressure sensor) from the air source (compressor tanks 260, 270, 285, or the like) at 310. If the air pressure is greater than a desired threshold, the DPF regeneration process can proceed. If the air pressure is not greater than the desired threshold, the controller can generate an alarm and/or stop the method 300, or generate an alarm and notify the system or a user to start the vehicle and/or the vehicle compressor to e.g., pump compressed air to the air source (compressor tanks 260, 270, 285, or the like). That is, the controller can ensure the amount of air needed for DPF regeneration is less than the amount of air in the air source.

Embodiments disclosed herein can utilize the time when the prime mover 210 of FIG. 2 is not running (i.e., free time) while the vehicle prime mover is running (i.e., free power from the vehicle) to conduct DPF regeneration. In case the vehicle prime mover is not running, and the prime mover 210 is running, the need for DPF regeneration (e.g., when the sensed pressure of the DPF exceeds a threshold) can trigger shutting down the prime mover 210 to conduct DPF regeneration. When conducting DPF regeneration, the prime mover 210 is off, and the vehicle prime mover can be either on or off.

It will be appreciated that embodiments disclosed herein can use different air source(s) on the vehicle that is not compressed air, can identify a place in the system where the air supply may be considered “compressed air” even though the vehicle compressor provided the air to it, can provide different ways to meter or control the airflow, and can provide independent tank(s) the compressed air system fills so that the tank is not considered as part of the vehicle.

### Aspects:

It is appreciated that any of aspects 1-7 and 8-14 can be combined.

Aspect 1. A diesel particulate filter regeneration system for a transport climate control system, comprising:

a prime mover having an ON state and an OFF state;

a diesel particulate filter (DPF) disposed downstream from the prime mover;

an airflow control device disposed upstream from the DPF;

an air source configured to provide air to the DPF via the airflow control device; and

a controller,

wherein the air source is configured to supply air to air components of a vehicle,

wherein when the prime mover is in the OFF state, the controller is configured to control the airflow control device to supply air from the air source to the DPF for diesel particulate filter regeneration.

Aspect 2. The system according to aspect 1, further comprising:

a heater disposed downstream from the prime mover and upstream from the DPF,

wherein the heater is disposed downstream from the airflow control device, and

the controller is configured to control the heater to provide heat to the DPF for diesel particulate filter regeneration.

Aspect 3. The system according to aspect 1, further comprising:

a heater integrated with the DPF,

wherein the heater is disposed downstream from the airflow control device, and

the controller is configured to control the heater to provide heat to the DPF for diesel particulate filter regeneration.

Aspect 4. The system according to any one of aspects 1-3, wherein the prime mover is a prime mover of an auxiliary power unit.

Aspect 5. The system according to any one of aspects 1-3, wherein the prime mover is a prime mover of the transport climate control system.

Aspect 6. The system according to any one of aspects 1-5, wherein the air source is a vehicle compressor air tank configured to store compressed air from a vehicle compressor and to supply the compressed air to the air components of the vehicle.

Aspect 7. The system according to any one of aspects 1-6, wherein the airflow control device is a solenoid valve, an orifice, or a check valve.

Aspect 8. A method for diesel particulate filter regeneration for a transport climate control system, the method comprising:

determining that a prime mover is in an OFF state;

when the prime mover is determined to be in the OFF state, a controller instructing an airflow control device to supply air from an air source to a diesel particulate filter (DPF) for diesel particulate filter regeneration, wherein the DPF is disposed downstream from the prime mover, and the airflow control device is disposed upstream from the DPF; and

the air source supplying air to the DPF via the airflow control device, wherein the air source is configured to supply air to air components of a vehicle.

Aspect 9. The method according to aspect 8, further comprising:

controlling, by the controller, a heater to provide heat to the DPF for diesel particulate filter regeneration,

wherein the heater is disposed downstream from the prime mover and upstream from the DPF, and

the heater is disposed downstream from the airflow control device.

Aspect 10. The method according to aspect 8, further comprising:

controlling, by the controller, a heater to provide heat to the DPF for diesel particulate filter regeneration,

wherein the heater is integrated with the DPF, and

the heater is disposed downstream from the airflow control device.

Aspect 11. The method according to any one of aspects 8-10, wherein the prime mover is a prime mover of an auxiliary power unit.

Aspect 12. The method according to any one of aspects 8-10, wherein the prime mover is a prime mover of the transport climate control system.

Aspect 13. The method according to any one of aspects 8-12, wherein the air source is a vehicle compressor air tank configured to store compressed air from a vehicle compressor and to supply the compressed air to the air components of the vehicle.

Aspect 14. The method according to any one of aspects 8-13, wherein the airflow control device is a solenoid valve, an orifice, or a check valve.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A diesel particulate filter regeneration system for a transport climate control system, comprising:
a prime mover having an ON state and an OFF state;
a diesel particulate filter (DPF) disposed downstream from the prime mover;
an airflow control device upstream from the DPF;
an air source configured to provide air to the DPF via the airflow control device; and
a controller,
wherein the air source is configured to supply air to air components of a vehicle,
wherein when the prime mover is in the OFF state, the controller is configured to control the airflow control device to supply air from the air source to the DPF for diesel particulate filter regeneration.

2. The system according to claim 1, further comprising:
a heater disposed downstream from the prime mover and upstream from the DPF,
wherein the heater is disposed downstream from the airflow control device, and
the controller is configured to control the heater to provide heat to the DPF for diesel particulate filter regeneration.

3. The system according to claim 1, further comprising:
a heater integrated with the DPF,
wherein the heater is disposed downstream from the airflow control device, and
the controller is configured to control the heater to provide heat to the DPF for diesel particulate filter regeneration.

4. The system according to claim 1, wherein the prime mover is a prime mover of an auxiliary power unit.

5. The system according to claim 1, wherein the prime mover is a prime mover of the transport climate control system.

6. The system according to claim 1, wherein the air source is a vehicle compressor air tank configured to store compressed air from a vehicle compressor and to supply the compressed air to the air components of the vehicle.

7. The system according to claim 1, wherein the airflow control device is a solenoid valve, an orifice, or a check valve.

8. A method for diesel particulate filter regeneration for a transport climate control system, the method comprising:
determining that a prime mover is in an OFF state;
when the prime mover is determined to be in the OFF state, a controller instructing an airflow control device to supply air from an air source to a diesel particulate filter (DPF) for diesel particulate filter regeneration, wherein the DPF is disposed downstream from the prime mover, and the airflow control device is disposed upstream from the DPF; and
the air source supplying air to the DPF via the airflow control device, wherein the air source is configured to supply air to air components of a vehicle.

9. The method according to claim 8, further comprising:
controlling, by the controller, a heater to provide heat to the DPF for diesel particulate filter regeneration,
wherein the heater is disposed downstream from the prime mover and upstream from the DPF, and
the heater is disposed downstream from the airflow control device.

10. The method according to claim 8, further comprising:
controlling, by the controller, a heater to provide heat to the DPF for diesel particulate filter regeneration,
wherein the heater is integrated with the DPF, and
the heater is disposed downstream from the airflow control device.

11. The method according to claim 8, wherein the prime mover is a prime mover of an auxiliary power unit.

12. The method according to claim 8, wherein the prime mover is a prime mover of the transport climate control system.

13. The method according to claim 8, wherein the air source is a vehicle compressor air tank configured to store compressed air from a vehicle compressor and to supply the compressed air to the air components of the vehicle.

14. The method according to claim 8, wherein the airflow control device is a solenoid valve, an orifice, or a check valve.
